(19) United States
(12) Patent Application Publication
(10) Pub. No.: US 2006/0114230 A1
(43) Pub. Date: Jun. 1, 2006

(54) Photo-controlled swing-metering controller

(76) Inventors: Wen Chin Lee, Taipei City (TW); Hsing Kuang Chen, Taipei City (TW)

Correspondence Address: LEONG C LEI, PMB # 1008, 1867 YGNACIO VALLEY ROAD, WALNUT CREEK, CA, 94598, US

(21) Appl. No.: 10/988,691

(22) Filed: Nov. 15, 2004

(51) Int. Cl. G09G 5/08

(52) U.S. Cl. 345/165

(57) ABSTRACT

A photo-controlled swing-metering controller includes a light-blocking plate connected to and synchronously swinging along with a swing wheel mechanism to cause changes in a light-source signal emitted from a photo-sensing device. The photo-sensing device detects the changed light-source signal and outputs an encoded signal, and discrimination of which enables the function of swing metering control.

### FIELD OF THE INVENTION

The present invention relates to a photo-controlled swing-metering controller in which a light-blocking plate is swung to control a light-source signal emitted from a photo-sensing device, and the photo-sensing device detects the changed light-source signal and outputs an encoded signal. Through discrimination of the encoded signal, the function of swing metering control can be achieved.

### BACKGROUND OF THE INVENTION

A conventional mouse provides different functions, including moving a cursor, clicking to select, and scrolling screen up and down. A currently available newest mouse provides not only the above-mentioned functions, but also the function of scrolling the screen vertically and horizontally.

FIG. 7 shows the swing and revolution metering control structure in a most recently available mouse. As shown, the structure includes a carriage mechanism A1, on which a swing wheel mechanism A2 capable of both swing and revolution metering controls is mounted. It can be clearly seen from FIG. 7, a pair of controlling press bars A4 are leftward and rightward extended from a housing of the swing wheel mechanism A2 to correspond to two micro-switches A5 mounted to left and right walls of the carriage mechanism A1. The swing wheel mechanism A2 takes advantage of left and right swing motions thereof to drive the two controlling press bars A4 to touch and trigger the micro-switches A5 on the left and right walls of the carriage mechanism A1, so as to achieve the function of swing metering control.

The swing wheel mechanism A2 shown in FIG. 7 includes a reset structure consisting of a spring clamp A6 providing an elastic clamping force, and a central resetting strip A61 driven by the elastic clamping force of the spring clamp A6 to reset the swing wheel mechanism A2. When the swing wheel mechanism A2 swings leftward and rightward, the spring clamp A6 generates a reverse spring force, which drives the central resetting strip A61 to push the swing wheel mechanism A2 back to a reset position to thereby achieve a reset function.

The above-described swing wheel mechanism A2 of the conventional mouse has the following disadvantages:
1. As mentioned above, the conventional swing wheel mechanism A2 utilizes the controlling press bars A4 to actuate the micro-switches A5. Therefore, a properly decided gap must be left between the controlling press bars A4 and the micro-switches A5 to control the swing motions of the swing wheel mechanism A2. When the gap is too small, it tends to cause incorrect operation of the micro-switches A5; and when the gap is too big, it tends to cause the problem of delayed operation of the micro-switches A5.
2. Since a relatively large swing force is needed to operate the micro-switches A5, a user tends to easily get tired during operation of the mouse.
3. The micro-switches A5 are mechanically operable and therefore have the problem of shortened usable life. That is, the micro-switches A5 tend to have poor contact or failure due to wearing in the operation thereof, and therefore shortened usable life.
4. The swing metering control structure with the micro-switches A5 is relatively complicate to result in increased labor and time, and accordingly increased manufacturing cost in assembling the structure.
5. Since the conventional swing-metering control structure of FIG. 7 uses micro-switches A5 as means to control the structure and uses two controlling press bars A4 extended from the left and the right wall of the swing wheel mechanism A2 to control the micro-switches A5, the whole swing-metering control structure has an overly large volume, preventing the structure from being applied in a relatively small mouse.

### SUMMARY OF THE INVENTION

It is a primary object of the present invention to provide a photo-controlled swing-metering controller that is photo-controlled to achieve the function of swing metering control to enable horizontal scrolling of a screen.

Another object of the present invention is to provide a photo-controlled swing-metering controller that uses a photo-sensing device to achieve the swing metering control to enable reduced volume and upgraded structural stability, reliability, and accuracy.

To achieve the above and other objects, the photo-controlled swing-metering controller according to the present invention mainly includes a swing wheel mechanism, a supporting base, a swing stem, a light-blocking plate, and a photo-sensing device. The swing wheel mechanism incorporates a rotary wheel mechanism having the function of revolution metering control. Since the rotary wheel mechanism is not a subject matter to be claimed in the present invention, it is not discussed in details.

The swing wheel mechanism includes front and rear pivot shafts turnably rested in front and rear holding recesses provided at front and rear ends of the supporting base. Therefore, the whole swing wheel mechanism has both the functions of swing and revolution metering control. The swing stem is connected to one of the two pivot shafts of the swing wheel mechanism to synchronously swing along with the swing wheel mechanism, and the light-blocking plate is integrally formed at a lower end of the swing stem to swing along with the latter. Swing motions of the light-blocking plate block or let through a light-source signal emitted from the photo-sensing device. The photo-sensing device detects the changed light-source signal and outputs a corresponding encoded signal. Through discrimination of the encoded signal, the function of swing metering control can be achieved.

The photo-controlled swing-metering controller according to the present invention has the following advantages:
1. It omits the left and right controlling press bars and the gaps between the controlling press bars and the micro-switches, and can therefore be operated in a more stable, reliable, and smooth manner without the problem of incorrect or delayed operation thereof.
2. It uses a photo-sensing device to replace the conventional micro-switches as means for swing metering control, which enables a user to operate a mouse with a largely reduced effort in controlling the swing without easily getting tired during the operation.
3. With the micro-switches replaced by the photo-sensing device, the swing-metering controller is changed from mechanical to electronic control that would largely increase the stability, reliability, and accuracy, as well as the usable life of the swing-metering controller.
4. With the micro-switches replaced by the photo-sensing device, the swing-metering controller of the present invention has simple and effective structure to largely reduce the procedures and time required to manufacture and assemble the swing-metering controller, enabling the same to be produced at reduced cost and more competitive in the market.
5. With the micro-switches replaced by the photo-sensing device, the swing-metering controller of the present invention has a largely reduced volume, enabling it to be applied in a relatively small mouse.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view best showing a photo-controlled swing-metering controller according to an embodiment of the present invention;

FIG. 2 is a perspective view of a photo-sensing device adopted in the present invention;

FIG. 3 schematically shows a swing stem and a light-blocking plate thereof included in the present invention in a reset state;

FIG. 4 schematically shows the swing stem and the light-blocking plate of FIG. 3 in left- and right-swung states;

FIG. 5 is a circuit diagram of the photo-sensing device included in the present invention;

FIG. 6 shows different time status and encoded signals of the photo-sensing device in the present invention; and

FIG. 7 schematically shows the structure of a conventional swing-metering controller.

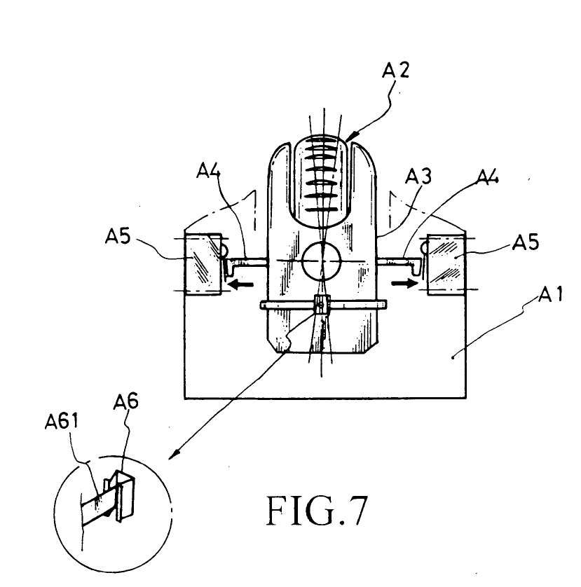

### DETAILED DESCRIPTION OF THE PREFERRED EMBODIMENTS

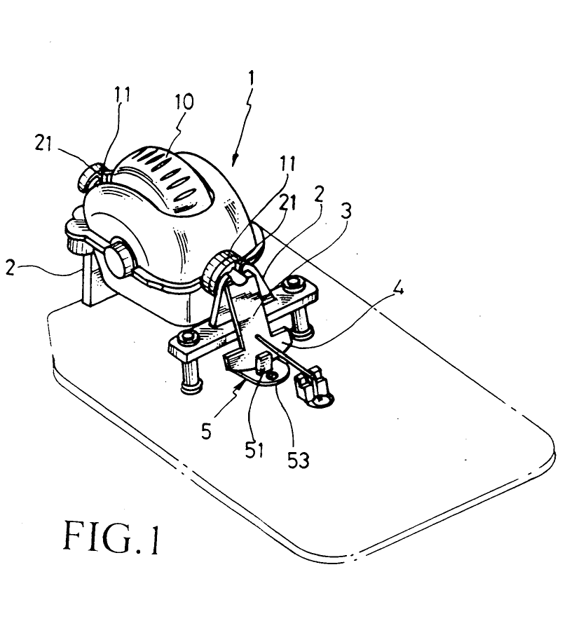

Please refer to FIG. 1 that is a perspective view of a photo-controlled swing-metering controller according to an embodiment of the present invention. As shown, the photo-controlled swing-metering controller of the present invention mainly includes a swing wheel mechanism 1, a supporting base 2, a swing stem 3, a light-blocking plate 4, and a photo-sensing device 5. The swing wheel mechanism 1 incorporates a rotary wheel mechanism 10 having the function of revolution metering control. Since the rotary wheel mechanism 10 is not a subject matter to be claimed in the present invention, it is not discussed in details. The swing wheel mechanism 1 includes front and rear pivot shafts 11 turnably rested in front and rear holding recesses 21 provided at front and rear ends of the supporting base 2. Therefore, the whole swing wheel mechanism 1 has both the functions of swing and revolution metering control.

As can be seen from FIG. 1, the swing stem 3 is extended from one of the two pivot shafts 11 of the swing wheel mechanism 1 to synchronously swing along with the swing wheel mechanism 1, and the light-blocking plate 4 is integrally formed at a lower end of the swing stem 3 to swing along with the latter. The light-blocking plate 4 is located in the photo-sensing device 5 to control a light-source signal emitted from the photo-sensing device 5.

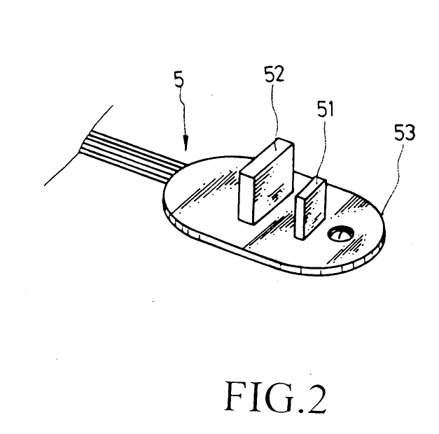

Please refer to FIG. 2. The photo-sensing device 5 includes a light-emitting diode (LED) 51 and a phototransistor unit 52 parallelly fixedly arranged on a circuit board 53.

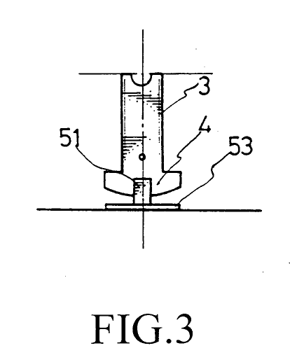

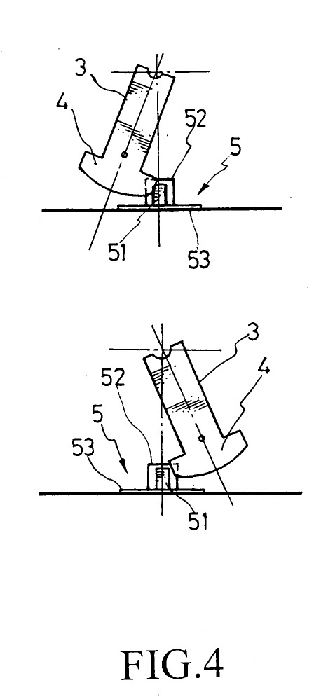

When the light-blocking plate 4 is located at a reset position in alignment with the photo-sensing device 5 as shown in FIG. 3, a light-source signal emitted from the LED 51 is completely blocked by the light-blocking plate 4, and the photo-sensing device 5 detects a light-source-blocked signal. And, when the light-blocking plate 4 is swung in and relative to the photo-sensing device 5 as shown in FIG. 4, the light-source signal emitted from the LED 51 is under control of swing motions of the light-blocking plate 4. Thus, a swing signal of the light-blocking plate 4 could be retrieved using the photo-sensing device 5 to detect changes in the light-source signal emitted therefrom.

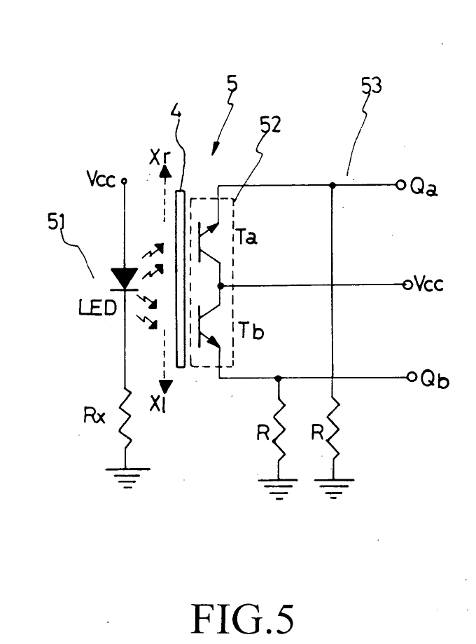

FIG. 5 shows a circuit diagram of the photo-sensing device 5. Wherein, the phototransistor unit 52 consists of two phototransistor elements Ta, Tb, and the LED 51 constantly emits a light-source signal, which changes with the swing motions of the light-blocking plate 4 in two different directions Xr and Xl. The phototransistor unit 52 detects changes in the light-source signal, and outputs an encoded signal via Qa and Qb to serve as a discriminating signal in swing metering control.

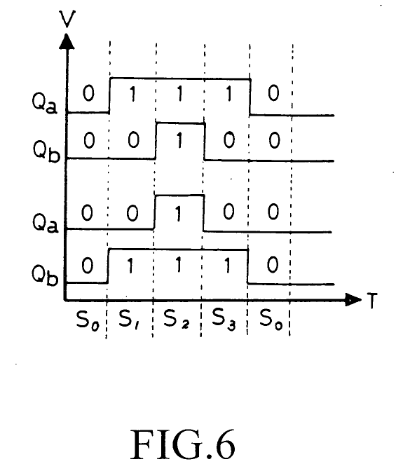

FIG. 6 shows different encoded signals generated by the phototransistor unit 52 at different time status. The Qa and Qb signals at an upper part of FIG. 6 are encoded signals generated by the phototransistor unit 52 when the light-blocking plate 4 swings in the direction Xl, and the Qa and Qb signals at a lower part of FIG. 6 are encoded signals generated by the phototransistor unit 52 when the light-blocking plate 4 swings in the direction Xr.

S0, S1, S2, and S3 are time status representing different encoded signals generated when the light-blocking plate 4 swings. Time status S0 represents the encoded signal generated when the light-blocking plate 4 is at the reset position; time status S1 represents the encoded signal generated when the light-blocking plate 4 starts swinging; time status S2 represents the encoded signal generated when the light-blocking plate 4 completes a swing motion; and time status S3 represents the encoded signal generated when the light-blocking plate 4 is ready for returning to the reset position. Therefore, the function of swing metering control could be achieved through discrimination of encoded signals at different time status S0, S1, S2, and S3.

What is claimed is:

1. A photo-controlled swing-metering controller, comprising a swing wheel mechanism, a supporting base, a swing stem connected to said swing wheel mechanism, a light-blocking plate integrally formed at a predetermined position on said swing stem, and a photo-sensing device;
said swing wheel mechanism including front and rear pivot shafts turnably rested in two holding recesses provided at front and rear ends of said supporting base, such that said swing wheel mechanism, said swing stem connected to said swing wheel mechanism, and said light-blocking plate swing synchronously;
said light-blocking plate being located in said photo-sensing device to control a light-source signal from said photo-sensing device via swing motions of said light-blocking plate in and relative to said photo-sensing device; and
said photo-sensing device being capable of detecting a light-source signal controlled by said light-blocking plate and output a corresponding encoded signal; such that a function of swing metering control can be achieved through discriminating said encoded signal output by said photo-sensing device.

2. The photo-controlled swing-metering controller as claimed in claim 1, wherein said photo-sensing device includes a light-emitting diode and a phototransistor unit parallelly and correspondingly arranged on a circuit board, and said phototransistor unit consisting of two phototransistor elements.
